(19) United States
(12) Patent Application Publication
(10) Pub. No.: US 2024/0296448 A1
(43) Pub. Date: Sep. 5, 2024

(54) DISTRIBUTED LEDGER DATA MANAGEMENT SYSTEM AND DATA MANAGEMENT METHOD

(71) Applicant: Hitachi, Ltd., Tokyo (JP)

(72) Inventors: Koshi IKEGAWA, Tokyo (JP); Nao NISHIJIMA, Tokyo (JP)

(21) Appl. No.: 18/240,368

(22) Filed: Aug. 31, 2023

(30) Foreign Application Priority Data
Mar. 3, 2023 (JP) 2023-033195

(51) Int. Cl. G06Q 20/40; G06Q 20/36

(52) U.S. Cl. CPC G06Q 20/401; G06Q 20/36; G06Q 20/389

(57) ABSTRACT

A secret key needed for access to a wallet or data movement is managed in a non-centralized manner. A distributed ledger data management system 10 includes a blockchain distributed ledger system (an asset management distributed ledger 11) which is configured to have a plurality of distributed ledger nodes (asset management distributed ledger nodes 22) and a distributed ledger network (an asset management distributed ledger network 21), and a plurality of utilization group systems which each manage, as a corresponding one of respective clients for a plurality of utilization groups for individuals and organizations participating in the distributed ledger system, a wallet of the utilization group for the individual or the organization. The utilization group system for the organization (a system for a utilization group 13) issues a transaction to the distributed ledger system by using an encrypted secret key of the organization when the wallet of the organization is used.

### CROSS-REFERENCE TO RELATED APPLICATION

The present application claims priority from Japanese application JP2023-033195, filed on Mar. 3, 2023, the content of which is hereby incorporated by reference into this application.

### BACKGROUND OF THE INVENTION

### Field of the Invention

The present invention relates to a distributed ledger data management system and a data management method and is suitably applied to a distributed ledger data management system and a data management method for managing data exchange among individuals and organizations participating in a distributed ledger.

### Description of the Related Art

To implement DFFT (data free flow with trust) proposed by the Japanese government in 2019, a system in which a plurality of organizations, such as the country and enterprises, share and utilize data is needed. As one implementation tool, a distributed ledger technology which allows a plurality of organizations to operate a system with the same authority is present. The distributed ledger technology is a technology which makes a deal in a direct manner of P2P (peer to peer) between utilizers, instead of making such a deal via a centralized institution (e.g., a reliable organization, such as a financial institution or a government), as having been made.

Various technologies derivative from a distributed ledger technology have been proposed, and the distributed ledger technology is continuing to evolve. A first one of current main features is, in a deal between participants in a distributed ledger, to nail down the deal not by a centralized institution but through consensus formation or approval by (arbitrary or particular) participants in the deal. A second one is to put together a plurality of transactions into a block, string blocks and record the blocks in a distributed ledger called a blockchain (BC), and perform hash calculation on continuous blocks to make tampering virtually impossible. A third one is to allow confirmation of a deal by all participants by sharing the same ledger data among all the participants.

Since a distributed ledger technology using a blockchain has the above-described features, application of the distributed ledger technology is being considered in a wide range of fields such as financial business and manufacturing business, as a mechanism to manage and share reliable data, and make and manage deals based on an agreement. Specifically, use of a distributed ledger technology like a blockchain (BC) technology makes it possible to make a money exchange between individuals in a non-centralized manner without tampering. As a result, the idea of a central bank digital currency (CBDC) is being advanced, and legal currencies all over the world are being digitalized.

For example, Japanese Patent No. 7108253 discloses, as a data management technology in a system utilizing a blockchain, an information disclosure management apparatus which accepts from a first utilizer, data as an object to be broadcast, accepts from a second utilizer, approval for broadcasting of the data, and, when a demand for disclosure is accepted from a third utilizer, broadcasts the data if a utilizer-related condition determined in advance by the second utilizer is satisfied.

For example, Japanese Patent Laid-Open No. 2021-189431 discloses a technology for guaranteeing security and privacy in blockchain privacy data processing by executing a smart contract with data concealed in handling data in a blockchain.

In a distributed ledger system using a distributed ledger technology (e.g., a digital currency system), a user which utilizes digital currency needs to own a wallet for retaining and managing a secret key needed to send or receive currency. The related art is problematic in how to manage a wallet. Specifically, if an individual manages a wallet for a distributed ledger which manages data including digital currency and assets and ownership of the digital currency and assets, the individual may manage a secret key needed for data retention. However, a case where an organization manages a wallet suffers the problem of dependency of secret key management on a particular individual. The above-described conventional technology in Japanese Patent No. 7108253 manages a secret key in a centralized manner with the information disclosure management apparatus and does not solve the problem. A solution to the problem is not disclosed in the conventional technology in Japanese Patent Laid-Open No. 2021-189431.

The present invention has been made in view of the above-described circumstances, and is intended to propose a distributed ledger data management system and a data management method capable of, in a case where an organization manages a wallet in a distributed ledger system, managing a secret key needed for access to the wallet or data movement, in a non-centralized manner.

### SUMMARY OF THE INVENTION

To solve the above-described problem, according to the present invention, there is provided a distributed ledger data management system for managing data exchange among utilization groups for individuals and organizations participating in a distributed ledger system, including a blockchain distributed ledger system which is configured to have a plurality of distributed ledger nodes and a distributed ledger network constructed from the plurality of distributed ledger nodes coupled to each other, and a plurality of utilization group systems which each manage, as a corresponding one of respective clients for a plurality of utilization groups for individuals and organizations participating in the distributed ledger system, a wallet of the utilization group for the individual or the organization, wherein the utilization group system for the organization issues a transaction to the distributed ledger system by using an encrypted secret key of the organization when the wallet of the organization is used.

To solve the above-described problem, according to the present invention, there is provided a data management method by a distributed ledger data management system for managing data exchange among utilization groups for individuals and organizations participating in a distributed ledger system, wherein the distributed ledger data management system has a blockchain distributed ledger system which is configured to have a plurality of distributed ledger nodes and a distributed ledger network constructed from the plurality of distributed ledger nodes coupled to each other, and a plurality of utilization group systems which each manage, as a corresponding one of respective clients for a plurality of utilization groups for individuals and organizations participating in the distributed ledger system, a wallet of the utilization group for the individual or the organization, and the utilization group system for the organization issues a transaction to the distributed ledger system by using an encrypted secret key of the organization when the wallet of the organization is used.

According to the present invention, it is possible to, in a case where an organization manages a wallet in a distributed ledger system, manage a secret key needed for access to the wallet or data movement in a non-centralized manner.

### BRIEF DESCRIPTION OF THE DRAWINGS

FIG. 1 is a diagram showing an example of an overall configuration of a distributed ledger data management system 10 according to one embodiment of the present invention;

FIG. 2 is a diagram showing an example of a configuration of an asset management distributed ledger 11;

FIG. 3 is a diagram showing an example of a configuration of a wallet management distributed ledger 17;

FIG. 4 is a diagram showing an example of a hardware configuration of a wallet management distributed ledger node 32;

FIG. 5 is a diagram showing an example of a hardware configuration of a wallet management distributed ledger client 18;

FIG. 6 is a chart showing one example of key information;

FIG. 7 is a chart showing one example of user information;

FIG. 8 is a chart showing one example of workflow information;

FIG. 9 is a chart showing one example of transaction information;

FIG. 10 is a flowchart showing an example of a procedure when the wallet management distributed ledger 17 is launched; and

FIG. 11 is a flowchart showing an example of a procedure for a process related to steps from application for a workflow to execution of a transaction in an organizational utilization group 13.

### DETAILED DESCRIPTION OF THE PREFERRED EMBODIMENT

An embodiment of the present invention will be described below in detail with reference to the drawings.

Note that the following description and the drawings are examples for describing the present invention and are omitted and simplified as appropriate for clarification of the description. All of combinations of features described in the embodiment are not essential for a solution of the invention. The present invention is not limited to the embodiment, and every application example in conformity with the idea of the present invention is included in the technical scope of the present invention. Various additions, changes, and the like can be made to the present invention by those skilled in the art without departing from the scope of the present invention. The present invention can be implemented in other various forms. The number of each component may be one or more than one unless otherwise limited.

In the following description, various types of information may be described using expressions, such as “table, ” “list, ” and “queue, ” but the various types of information may also be expressed using data structures other than tables, lists, and queues. An “XX table, ” an “XX list, ” or the like may be called “XX information” to indicate that the information does not depend on the data structure. An expression, such as “identification information, ” “identifier, ” “name, ” “ID, ” or “number, ” is used in describing a content of each piece of information, but the expressions can be replaced with each other.

In the following description, a reference character or a common numeral in a reference character may be used to describe elements of the same type without any distinction therebetween, and reference characters for elements of the same type may be used or IDs assigned to the elements may be used instead of the reference characters to distinctively describe the elements.

In the following description, a process to be performed through execution of a program may be described. Since a program performs a defined process using, for example, storage resources (e.g., a memory) and/or an interface device (e.g., a communication port) by being executed by at least one processor (e.g., a CPU), the subject of the process may be regarded as the processor. Similarly, the subject of the process to be performed through execution of the program may be a controller, an apparatus, a system, a computer, a node, a storage system, a storage apparatus, a server, a management computer, a client, or a host having a processor. The subject (e.g., a processor) of the process to be performed through execution of the program may include a hardware circuit which performs a part or the whole of the process. For example, the subject of the process to be performed through execution of the program may include a hardware circuit which performs encryption and decryption or compression and expansion. A processor acts as a functional unit which implements a predetermined function by acting in accordance with the program. An apparatus and system including the processor is an apparatus and system including such functional units.

A program may be installed from a program source onto an apparatus, such as a computer. The program source may be, for example, a program distribution server or a computer-readable, non-transitory storage medium. If the program source is a program distribution server, the program distribution server may include a processor (e.g., a CPU) and non-transitory storage resources, and the storage resources may further store a distribution program and a program as an object to be distributed. The processor of the program distribution server may distribute the program as the object to be distributed to other computers through execution of the distribution program by the processor of the program distribution server. In the following description, two or more programs may be implemented as one program or one program may be implemented as two or more programs.

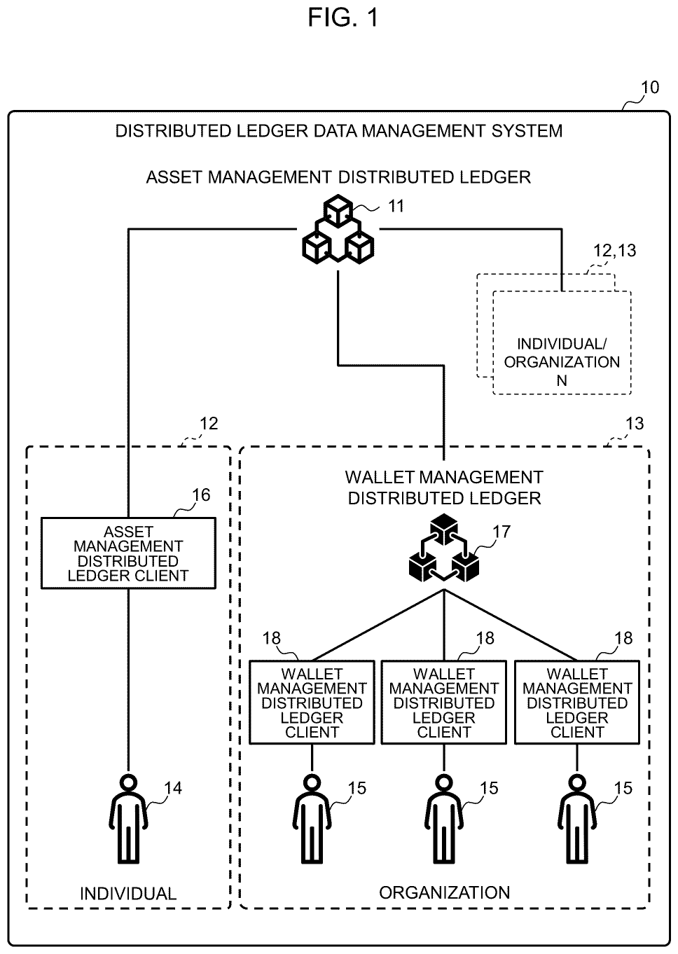

FIG. 1 is a diagram showing an example of an overall configuration of a distributed ledger data management system 10 according to one embodiment of the present invention. The distributed ledger data management system 10 is a system for managing data exchange among individuals and organizations participating in a distributed ledger system (an asset management distributed ledger 11). As shown in FIG. 1, one or more individual utilization groups 12 and one or more organizational utilization groups 13 are participating in the asset management distributed ledger 11. One utilizer 14 utilizes one of the individual utilization groups 12, and one organization (a plurality of utilizers 15 belonging to the organization) utilizes one of the organizational utilization groups 13.

In the individual utilization group 12, an asset management distributed ledger client 16 manages a wallet of a corresponding individual, and the asset management distributed ledger client 16 performs reading and writing of data from and to the asset management distributed ledger 11 in accordance with a manipulation by the single utilizer 14.

In the organizational utilization group 13, a wallet management distributed ledger 17 manages a wallet of a corresponding organization, and the wallet management distributed ledger 17 performs reading and writing of data from and to the asset management distributed ledger 11. In the organizational utilization group 13, a plurality of wallet management distributed ledger clients 18 which the utilizers 15 of the organization manipulate are coupled to the wallet management distributed ledger 17, and each wallet management distributed ledger client 18 performs reading and writing of data from and to the wallet management distributed ledger 17 in accordance with a manipulation by the utilizer 15 of the organization.

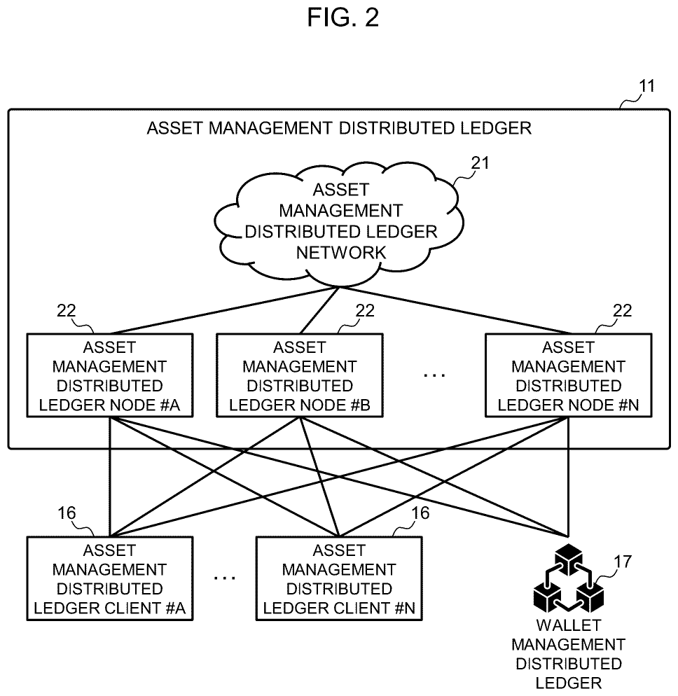

FIG. 2 is a diagram showing an example of a configuration of the asset management distributed ledger 11. The asset management distributed ledger 11 is a distributed ledger including a blockchain which is configured such that a plurality of asset management distributed ledger nodes 22 communicate with each other via an asset management distributed ledger network 21.

The asset management distributed ledger 11 may be a public blockchain and distributed ledger, such as Bitcoin (R) or Ethereum (R), in which anyone can participate, or a permissioned blockchain and distributed ledger like Hyperledger Fabric (R) in which a permitted user or organization can participate. The asset management distributed ledger 11 is configured to be capable of handling fungible tokens (FTs) including currency like crypto-assets, and be capable of handling non-fungible tokens (NFTs) including an art piece, real estate, or a game character.

As shown in FIG. 2, reading and writing of data from and to the asset management distributed ledger 11 (the plurality of asset management distributed ledger nodes 22 coupled via the asset management distributed ledger network 21) are performed via the asset management distributed ledger client 16 for the individual utilization group 12 or the wallet management distributed ledger 17 of the organizational utilization group 13. Note that the number of asset management distributed ledger nodes 22, the number of asset management distributed ledger clients 16, and the number of wallet management distributed ledgers 17 may be respective arbitrary numbers.

When the asset management distributed ledger client 16 performs reading or writing from or to the asset management distributed ledger 11, a wallet including a secret key is necessary.

The asset management distributed ledger 11 and the wallet management distributed ledger 17 communicate with each other using an interoperability technology which allows intercommunication in which blockchains and distributed ledgers can perform reading and writing from and to each other.

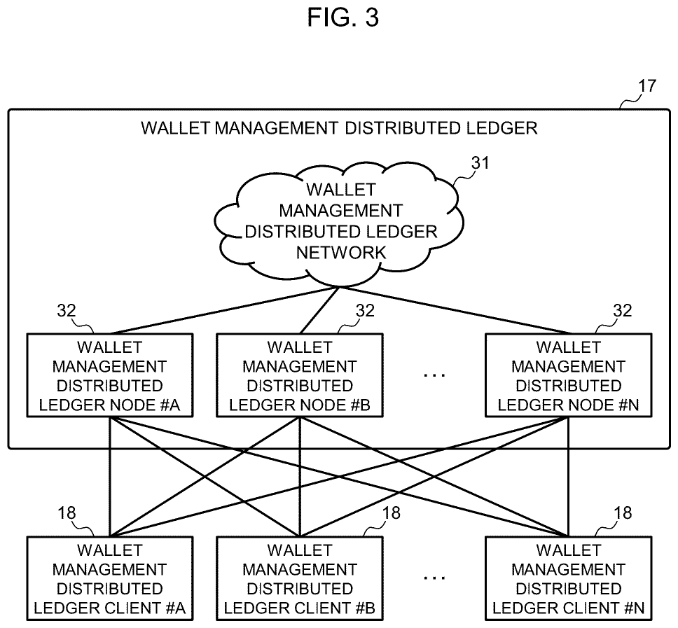

FIG. 3 is a diagram showing an example of a configuration of the wallet management distributed ledger 17. The wallet management distributed ledger 17 is a distributed ledger including a blockchain which is configured such that a plurality of wallet management distributed ledger nodes 32 communicate with each other via a wallet management distributed ledger network 31.

The wallet management distributed ledger 17 is a permissioned blockchain and distributed ledger like Hyperledger Fabric in which a permitted user or organization can participate.

As shown in FIG. 3, reading and writing of data from and to the wallet management distributed ledger 17 (the plurality of wallet management distributed ledger nodes 32 coupled via the wallet management distributed ledger network 31) are performed via the wallet management distributed ledger client 18 of the organizational utilization group 13. Note that the number of wallet management distributed ledger nodes 32 and the number of wallet management distributed ledger clients 18 may be respective arbitrary numbers.

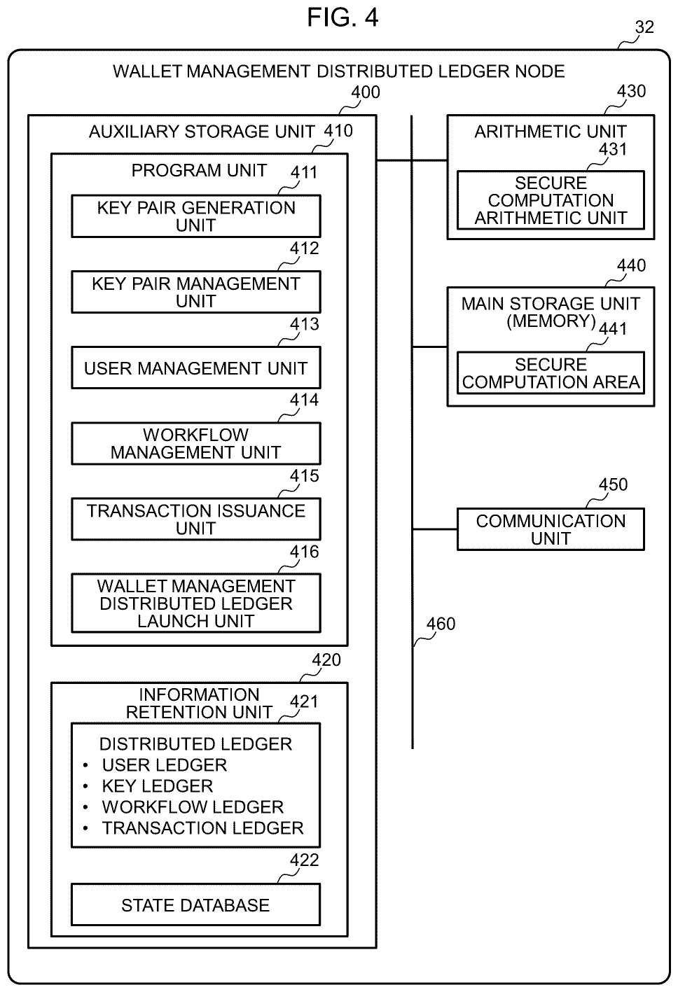

FIG. 4 is a diagram showing an example of a hardware configuration of the wallet management distributed ledger node 32. As shown in FIG. 4, the wallet management distributed ledger node 32 includes an auxiliary storage unit 400, an arithmetic unit 430, a main storage unit (memory) 440, and a communication unit 450, and the units are coupled via a bus 460.

The arithmetic unit 430 is a processor which executes a program in a program unit 410 that is retained in the auxiliary storage unit 400 by reading the program into the main storage unit 440, controls the apparatus (the wallet management distributed ledger node 32) itself in an integrated manner, and performs various types of judgments, arithmetics, and control processes. Specifically, the arithmetic unit 430 is, for example, a CPU (central processing unit).

The arithmetic unit 430 has a secure computation arithmetic unit 431. The secure computation arithmetic unit 431 can have a secure computation area 441 inside an area of the main storage unit 440 and execute secure computation in the secure computation area 441 by using a TEE (trusted execution environment) technology which encrypts a part of the area of the main storage unit 440.

Note that the secure computation arithmetic unit 431 and the secure computation area 441 may each be a secure computation execution environment which is constructed by one of secure computation technologies including secure multi-party computation (MPC) and a zero-knowledge proof.

The program unit 410 and an information retention unit 420 are stored in the auxiliary storage unit 400.

The program unit 410 has a key pair generation unit 411, a key pair management unit 412, a user management unit 413, a workflow management unit 414, a transaction issuance unit 415, and a wallet management distributed ledger launch unit 416.

The key pair generation unit 411 is a program which generates a key pair composed of a secret key and a public key of the wallet management distributed ledger 17. The secret key of the wallet management distributed ledger 17 is a secret key needed to use the wallet of the organization for the utilization group 13. The key pair management unit 412 is a program having a function of managing the key pair generated by the key pair generation unit 411. The user management unit 413 is a program having a function of managing user information, authority, and the like. The workflow management unit 414 is a program having a function of implementing a business flow for application or approval for transaction issuance or the like in the transaction issuance unit 415. The transaction issuance unit 415 is a program having a function of managing transaction issuance. The wallet management distributed ledger launch unit 416 is a program having a function of constructing the wallet management distributed ledger network 31.

Of the various types of programs managed by the program unit 410, the programs other than the wallet management distributed ledger launch unit 416 are read into the secure computation area 441 in the main storage unit (memory) 440 through the bus 460 and are then executed by the secure computation arithmetic unit 431 of the arithmetic unit 430. A result of the execution is stored in the information retention unit 420.

The information retention unit 420 has a distributed ledger 421 and a state database 422.

The distributed ledger 421 is data obtained by stringing pieces of data, each of which is called a block and is composed of transactions put together, and is a blockchain. A user ledger which holds user information, a key ledger which holds key information, a workflow ledger which holds workflow information, and a transaction ledger which holds transaction information are included in the distributed ledger 421.

The state database 422 is a database for saving latest table data at the time of execution of a transaction managed in the transaction ledger of the distributed ledger 421.

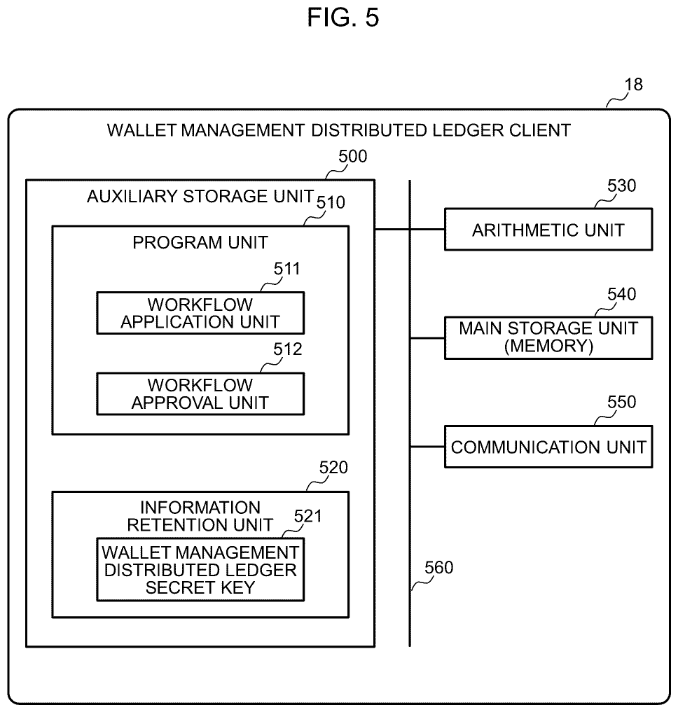

FIG. 5 is a diagram showing an example of a hardware configuration of the wallet management distributed ledger client 18. As shown in FIG. 5, the wallet management distributed ledger client 18 includes an auxiliary storage unit 500, an arithmetic unit 530, a main storage unit (memory) 540, and a communication unit 550, and the units are coupled via a bus 560.

The arithmetic unit 530 is a processor which executes a program in a program unit 510 which is retained in the auxiliary storage unit 500 by reading the program into the main storage unit 540, controls the apparatus (the wallet management distributed ledger client 18) itself in an integrated manner, and performs various types of judgments, arithmetics, and control processes. Specifically, the arithmetic unit 530 is, for example, a CPU (central processing unit).

The program unit 510 and an information retention unit 520 are stored in the auxiliary storage unit 500.

The program unit 510 has a workflow application unit 511 and a workflow approval unit 512.

The workflow application unit 511 is a program having a function of managing application for a workflow from a user (the utilizer 15). The user performs reading and writing of data from and to the workflow management unit 414 of the wallet management distributed ledger node 32 through the workflow application unit 511. Data to be read and written via the workflow application unit 511 is information on application for a workflow to a user with superior authority, such as a request for execution of a transaction which transfers assets in the asset management distributed ledger 11 or a request for browsing.

The workflow approval unit 512 is a program having a function of managing approval for a workflow from a user (the utilizer 15). The user performs reading and writing of data from and to the workflow management unit 414 of the wallet management distributed ledger node 32 through the workflow approval unit 512. Data to be read and written via the workflow approval unit 512 is information on approval for a workflow in response to a request for execution of a transaction which transfers assets, a request for browsing, or the like from a user with inferior authority in the asset management distributed ledger 11. To give approval, a request to write data to the workflow management unit 414 to that effect is made.

The information retention unit 520 holds a wallet management distributed ledger secret key 521. The wallet management distributed ledger secret key 521 is a secret key which corresponds to an account of the utilizer 15 that utilizes the wallet management distributed ledger client 18 and is used at the time of processing between the individual wallet management distributed ledger client 18 and the wallet management distributed ledger 17, specifically, at the time of application and approval for a workflow. A method for generating the wallet management distributed ledger secret key 521 is not particularly limited. For example, the wallet management distributed ledger secret key 521 for an account is passed from a certificate authority (not shown) at the time of creation of the account and is stored in the information retention unit 520.

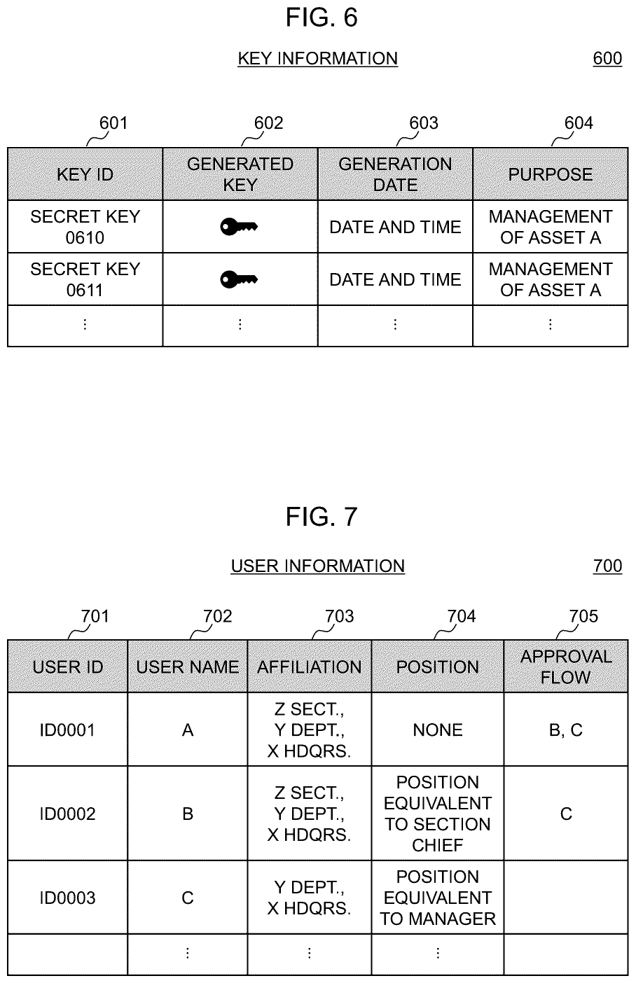

FIG. 6 is a chart showing one example of key information. Key information 600 shown in FIG. 6 is information on a key used at the time of utilization of the asset management distributed ledger 11 and is information which is saved in the state database 422 of the wallet management distributed ledger node 32. Note that similar key information is also managed in the key ledger of the distributed ledger of the wallet management distributed ledger node 32.

Specifically, when a key pair is generated by the key pair generation unit 411 of the wallet management distributed ledger node 32, information on the key pair including the encrypted key pair is written to the distributed ledger 421 by the key pair management unit 412, and the state database 422 is updated with latest information (the key information 600).

As shown in FIG. 6, the key information 600 uses, as a key, a key ID 601 indicating an identifier of the key to manage information on a generated key 602 which is a body of an encrypted key, a generation date 603 indicating a generation date and time of the key, and a purpose 604 indicating a purpose of the key.

FIG. 7 is a chart showing one example of user information. User information 700 shown in FIG. 7 is information on users (the utilizers 15) participating in the organizational utilization group 13 and is information which is saved in the state database 422 of the wallet management distributed ledger node 32. Note that similar user information is also managed in the user ledger of the distributed ledger of the wallet management distributed ledger node 32.

Specifically, when registration or updating of user information is performed by a manipulation by a manager or the like of the organizational utilization group 13, the information is written to the distributed ledger 421 by the user management unit 413, and the state database 422 is updated with latest information (the user information 700).

As shown in FIG. 7, the user information 700 uses, as a key, a user ID 701 indicating an identifier of a user (the utilizer 15) of the organization to manage information on a user name 702 indicating a name of the user, an affiliation 703 indicating an affiliation in the organization of the user, a position 704 indicating a position in the organization of the user, and an approval flow 705 indicating an approver for application from the user.

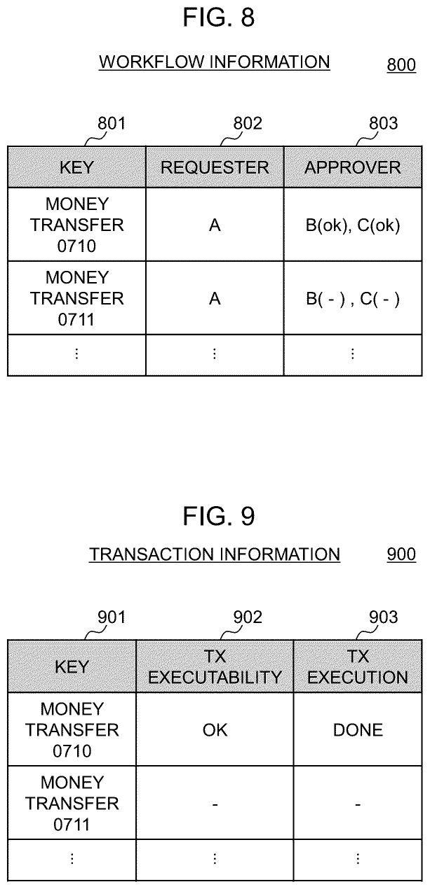

FIG. 8 is a chart showing one example of workflow information. Workflow information 800 shown in FIG. 8 is information on application and approval for a workflow and is information which is saved in the state database 422 of the wallet management distributed ledger node 32. Note that similar workflow information is also managed in the workflow ledger of the wallet management distributed ledger node 32.

As shown in FIG. 8, the workflow information 800 uses, as a key, a key 801 indicating an identifier assigned to each workflow application to manage information on a requester 802 indicating a requester of application and an approver 803 indicating an approver for the application. In the example in FIG. 8, the type of a transaction whose execution is demanded in the application is included in the identifier of the key 801. For example, the key 801 of “MONEY TRANSFER 0710” means that issuance of a transaction as a money transfer process is being applied for (“0710” is, for example, a serial number). Registration and updating of the workflow information 800 is performed by the workflow management unit 414.

Note that “ok” is registered for each approver in the approver 803 if the application is approved and that “-” is registered if the application is not approved. If an approval status changes, information registered as the approver 803 is updated by the workflow management unit 414.

FIG. 9 is a chart showing one example of transaction information. Transaction information 900 shown in FIG. 9 is information on execution (issuance) of a transaction which becomes executable after approval for application of a workflow and is information which is saved in the state database 422 of the wallet management distributed ledger node 32. Note that similar transaction information is also managed in the transaction ledger of the wallet management distributed ledger node 32.

As shown in FIG. 9, the transaction information 900 uses, as a key, a key 901 corresponding to the key 801 assigned to each workflow application to manage information on TX executability 902 indicating a status of executability of a transaction demanded in the application and TX execution 903 indicating an execution status of the transaction. The key 901 corresponds to the key 801 in the workflow information 800.

Registration and updating of the transaction information 900 is performed by the transaction issuance unit 415 (or the workflow management unit 414). For example, if approval is given by (“ok” is registered for) every approver in the approver 803 in a record of the workflow information 800 corresponding to the key 901, the transaction issuance unit 415 updates a content of the TX executability 902 with “OK” indicating that a transaction for the key 901 is executable. If the transaction for the key 901 is issued, the transaction issuance unit 415 updates a content of the TX execution 903 with “DONE. ” Note that, as another processing method related to updating of the TX executability 902, for example, the workflow management unit 414 may update the TX executability 902 in accordance with an updated content of the workflow information 800 and, if the TX executability 902 is “OK, ” notify the transaction issuance unit 415.

A process to be executed by the distributed ledger data management system 10 will be described below using the above-described configuration of the distributed ledger data management system 10 and various types of data examples.

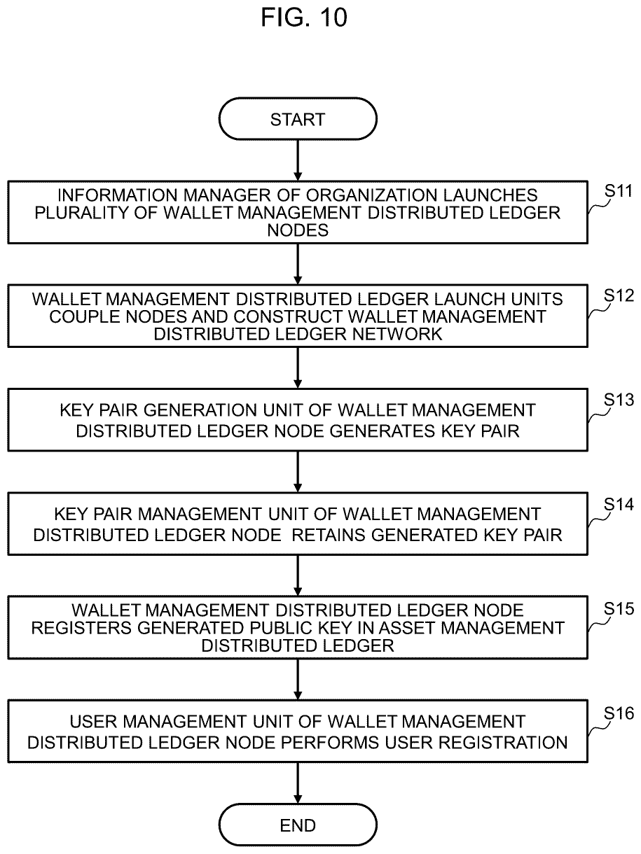

FIG. 10 is a flowchart showing an example of a procedure when the wallet management distributed ledger 17 is launched. A process shown in FIG. 10 is available for a process of initializing the wallet management distributed ledger 17.

In FIG. 10, a manager of the organization performs a manipulation of launching the plurality of wallet management distributed ledger nodes 32 (step S11). As a result, the wallet management distributed ledger client 18 transmits a launch demand to the plurality of wallet management distributed ledger nodes 32, and the wallet management distributed ledger launch unit 416 of the program unit 410 is launched in each of the plurality of wallet management distributed ledger nodes 32 that have received the demand.

The respective wallet management distributed ledger launch units 416 in the plurality of wallet management distributed ledger nodes 32 launched in step S11 are coupled to each other to construct the wallet management distributed ledger network 31 (step S12).

The key pair generation unit 411 of one of the wallet management distributed ledger nodes 32 generates a key pair (step S13). Note that, in step S13, one wallet management distributed ledger node 32 may take the lead, the key pair generation unit 411 thereof may generate a key pair, the key pair generation unit 411 in each of one or more other wallet management distributed ledger nodes 32 may simultaneously execute generation using a random seed which is needed for key pair generation and is equalized, and the wallet management distributed ledger node 32 having the lead may make an agreement by confirming that key pairs generated in the other nodes exactly match the key pair and decide to use the key pair.

The key pair management unit 412 of each wallet management distributed ledger node 32 retains the key pair generated by the one of the wallet management distributed ledger nodes 32 in step S13 by writing the key pair to the distributed ledger 421 therefor and updating the key information 600 in the state database 422 (step S14). Note that, in step S14, the key pair management unit 412 of the one wallet management distributed ledger node 32 that has taken the lead and has generated the key pair in step S13 may retain the key pair by writing the key pair to the distributed ledger 421 and updating the key information 600 in the state database 422.

The key pair management unit 412 registers a public key of the generated key pair in the asset management distributed ledger 11 to allow writing of a transaction to the asset management distributed ledger 11 using a secret key (step S15).

Finally, the user management unit 413 of the wallet management distributed ledger node 32 performs user registration (step S16), and the launch of the wallet management distributed ledger 17 ends.

With the above-described execution of the process shown in FIG. 10, the wallet management distributed ledger 17 that manages a secret key of the organization (the secret key needed to use the wallet of the organization) can be launched with a configuration in which a plurality of nodes (the wallet management distributed ledger nodes 32) are coupled to each other at the time of participation of the organizational utilization group 13 in the distributed ledger data management system 10.

In the above process, the processes by the key pair generation unit 411, the key pair management unit 412, and the user management unit 413 in steps S13 to S15 are all executed by secure computation in the secure computation area 441. Thus, in the wallet management distributed ledger 17, use of a secure computation function allows execution of a process related to generation and management of a key pair (notably the secret key) of the organization in a state where the process is concealed from the utilizers 15 belonging to the organizational utilization group 13, and dependency of management of the secret key of the organization on a particular individual can be avoided.

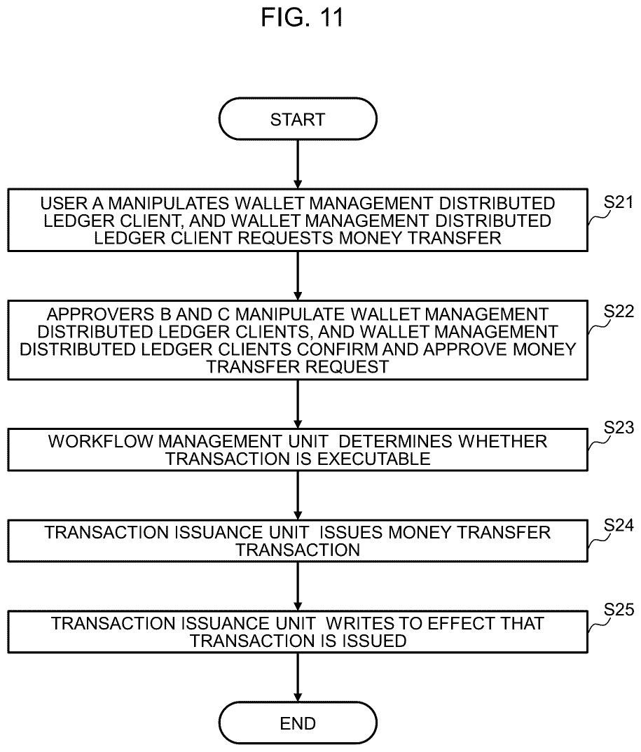

FIG. 11 is a flowchart showing an example of a procedure for a process related to steps from application for a workflow to execution of a transaction in the organizational utilization group 13.

FIG. 11 shows a series of procedures for: request for a process of “money transfer” (application for a workflow) by a “user A” indicated in the user information 700 in FIG. 7; approval by users B and C (see the approval flow 705 in the user information 700) which are approvers for the request (application) by the user A; and execution of a money transfer transaction by the transaction issuance unit 415 after transaction executability is determined. The users A, B, and C are the utilizers 15 belonging to the same organizational utilization group 13. Assume that the money transfer request made by the user A is the application corresponding to “MONEY TRANSFER 0710” indicated in the key 801 in the workflow information 800 in FIG. 8.

In FIG. 11, the user A first manipulates the wallet management distributed ledger client 18 thereof to input the request corresponding to “MONEY TRANSFER 0710.” At the time of the input, the user A sets the users B and C described in the approval flow 705 as approvers (step S21). In the wallet management distributed ledger client 18 that has accepted the input of the request from the user A, the workflow application unit 511 transmits application for a workflow corresponding to the request to the workflow management unit 414 of the wallet management distributed ledger node 32 in step S21. The workflow management unit 414 that has received the application saves information on the application in the state database 422 (the workflow information 800 and the transaction information 900). Additionally, the workflow management unit 414 may notify the wallet management distributed ledger clients 18 for the users B and C as the approvers of a request for approval for the application.

Each of the users B and C manipulates the wallet management distributed ledger client 18, confirms that an approval request to the user has reached the user (refers to the workflow information 800 and the transaction information 900 in the state database 422, to be more specific), and writes data to the effect that the user approves the application (step S22). If each of the users B and C performs a manipulation of writing approval in step S22, the workflow approval unit 512 of the wallet management distributed ledger client 18 notifies the workflow management unit 414 of the wallet management distributed ledger node 32 of the approval, and the workflow management unit 414 saves information on the approval in the state database 422 (the workflow information 800 and the transaction information 900).

When the workflow management unit 414 confirms that approval by all the approvers (the users B and C) is gained (that “ok” is registered for every approver in the approver 803 of a record with “MONEY TRANSFER 0710” in the workflow information 800), the workflow management unit 414 judges that a transaction corresponding to “MONEY TRANSFER 0710” is executable and writes “OK” to the TX executability 902 of the record with “MONEY TRANSFER 0710” in the transaction information 900 (step S23).

The transaction issuance unit 415 issues a money transfer transaction to the asset management distributed ledger 11 (step S24).

Finally, the transaction issuance unit 415 writes “DONE” to the TX execution 903 of the record with “MONEY TRANSFER 0710” in the transaction information 900 (step S25) and ends the process. Note that, in step S25, the transaction issuance unit 415 may further notify the wallet management distributed ledger client 18, in which the application is made by the user A in step S21, and the wallet management distributed ledger clients 18, in which the application is approved in step S22, of a completion report to the effect that the applied-for money transfer process is executed.

With the above-described execution of the process shown in FIG. 11, if application for a workflow is made by the utilizer 15 belonging to the organizational utilization group 13, and approval for the workflow is gained, the distributed ledger data management system 10 can issue a transaction corresponding to the application from the wallet management distributed ledger 17 to the asset management distributed ledger 11 by using the secret key of the organization. After that, the transaction is processed in the asset management distributed ledger 11.

As described with reference to the process in FIG. 10, the secret key of the organization that is generated in a concealed state (by secure computation) by the key pair generation unit 411 is managed in the key information 600 in a concealed state (while being kept encrypted). In the process in FIG. 11, processes to be executed by the wallet management distributed ledger node 32 are all executed by secure computation in the secure computation area 441, and the wallet management distributed ledger 17 issues a transaction to the asset management distributed ledger 11 by using the concealed secret key. Thus, at the time of use of the wallet of the organization, the wallet management distributed ledger 17 can implement steps from application for a workflow by the utilizer 15 to execution of a transaction in a state where the secret key used at the time of use of the wallet of the organization is concealed from the utilizer 15 (without dependency of management of the secret key of the organization on the utilizer 15).

Note that since a process as a response to a demand for money transfer or the like from the individual utilization group 12 is the same as a process in a conventional distributed management ledger system using a blockchain, a detailed description thereof will be omitted.

As described above, in order to manage a wallet itself of an organization needed for the organizational utilization group 13 participating in the asset management distributed ledger 11 as a distributed ledger system to use the asset management distributed ledger 11, the distributed ledger data management system 10 according to the present embodiment launches the wallet management distributed ledger 17 having a configuration in which a plurality of nodes (the wallet management distributed ledger nodes 32) are coupled to each other via the wallet management distributed ledger network 31 separately from the wallet and couples blockchains (the asset management distributed ledger 11 and the wallet management distributed ledger 17). Each wallet management distributed ledger node 32 uses a secure computation technology as a security function of the arithmetic unit 430 (CPU) to generate a key pair (a secret key and a public key) needed to use the wallet of the organization and encrypts and manages the keys themselves.

The distributed ledger data management system 10 configured in the above-described manner can manage a key (notably a secret key) needed to use a wallet of an organization in a non-centralized manner and can be operated in a state where a content of the key is concealed from users (including the utilizers 15 of the utilization group 13).

### REFERENCE SIGNS LIST

10 distributed ledger data management system
11 asset management distributed ledger
12, 13 utilization group
14, 15 utilizer
16 asset management distributed ledger client
17 wallet management distributed ledger
18 wallet management distributed ledger client
21 asset management distributed ledger network
22 asset management distributed ledger node
31 wallet management distributed ledger network
32 wallet management distributed ledger node
400, 500 auxiliary storage unit
410, 510 program unit
411 key pair generation unit
412 key pair management unit
413 user management unit
414 workflow management unit
415 transaction issuance unit
416 wallet management distributed ledger launch unit
420, 520 information retention unit
421 distributed ledger
422 state database
430, 530 arithmetic unit
431 secure computation arithmetic unit
440, 540 main storage unit (memory)
441 secure computation area
450, 550 communication unit
460, 560 bus
511 workflow application unit
512 workflow approval unit
521 wallet management distributed ledger secret key
600 key information
700 user information
800 workflow information
900 transaction information

What is claimed is:

1. A distributed ledger data management system for managing data exchange among utilization groups for individuals and organizations participating in a distributed ledger system, comprising:
a blockchain distributed ledger system which is configured to have a plurality of distributed ledger nodes and a distributed ledger network constructed from the plurality of distributed ledger nodes coupled to each other; and
a plurality of utilization group systems which each manage, as a corresponding one of respective clients for a plurality of utilization groups for individuals and organizations participating in the distributed ledger system, a wallet of the utilization group for the individual or the organization,
wherein the utilization group system for the organization issues a transaction to the distributed ledger system by using an encrypted secret key of the organization when the wallet of the organization is used.

2. The distributed ledger data management system according to claim 1, wherein
the utilization group system for the organization includes
a wallet management distributed ledger which manages the wallet of the utilization group for the organization and is coupled to the distributed ledger system, and
a plurality of wallet management distributed ledger clients which are terminals to be manipulated by a utilizer belonging to the utilization group for the organization and are coupled to the wallet management distributed ledger, and
the wallet management distributed ledger is launched in accordance with a launch demand from the wallet management distributed ledger client when the utilization group for the organization participates in the distributed ledger system, and the wallet management distributed ledger generates the secret key of the organization and manages the secret key in an encrypted state.

3. The distributed ledger data management system according to claim 2, wherein
the wallet management distributed ledger is a blockchain distributed ledger which is configured to have
a plurality of wallet management distributed ledger nodes which are launched in accordance with the launch demand from the wallet management distributed ledger client and issue a transaction to the distributed ledger system by using the encrypted secret key of the organization at the time of use of the wallet of the organization, and
a wallet management distributed ledger network which is constructed from the plurality of wallet management distributed ledger nodes coupled to each other, and
at least one of the plurality of wallet management distributed ledger nodes generates the secret key of the organization, and the plurality of wallet management distributed ledger nodes each manage the secret key in an encrypted state.

4. The distributed ledger data management system according to claim 3, wherein
the wallet management distributed ledger node has a secure computation function of executing an arithmetic in a concealed state and executes a process related to generation and management of the secret key of the organization by utilizing the secure computation function.

5. The distributed ledger data management system according to claim 4, wherein
the wallet management distributed ledger node manages, in a concealed state, the secret key of the organization generated in the concealed state and a public key paired with the secret key and issues a transaction to the distributed ledger system by using the concealed secret key.

6. The distributed ledger data management system according to claim 5, wherein
the wallet management distributed ledger client implements, through execution of a program,
a workflow application unit which executes a process related to application from a first utilizer in the organization demanding issuance of a predetermined transaction, and
a workflow approval unit which executes a process related to approval for the application by a second utilizer in the organization different from the first utilizer, and
the wallet management distributed ledger node implements, through execution of a program,
a workflow management unit which manages a workflow from the application to the approval through data exchange between the workflow application unit and the workflow approval unit and, if the approval for the application is completed, determines the issuance of the predetermined transaction, and
a transaction issuance unit which issues the transaction to the distributed ledger system in accordance with the determination of the issuance of the transaction by the workflow management unit.

7. The distributed ledger data management system according to claim 6, wherein
the wallet management distributed ledger client makes an exchange of information on the application and the approval with the wallet management distributed ledger node by using a secret key which is uniquely managed by the wallet management distributed ledger client.

8. A data management method by a distributed ledger data management system for managing data exchange among utilization groups for individuals and organizations participating in a distributed ledger system,
wherein the distributed ledger data management system has a blockchain distributed ledger system which is configured to have a plurality of distributed ledger nodes and a distributed ledger network constructed from the plurality of distributed ledger nodes coupled to each other, and a plurality of utilization group systems which each manage, as a corresponding one of respective clients for a plurality of utilization groups for individuals and organizations participating in the distributed ledger system, a wallet of the utilization group for the individual or the organization, and
the utilization group system for the organization issues a transaction to the distributed ledger system by using an encrypted secret key of the organization when the wallet of the organization is used.
